(19) United States
(12) Patent Application Publication
(10) Pub. No.: US 2020/0019795 A1
(43) Pub. Date: Jan. 16, 2020

(54) Generation Method, Apparatus, Electronic Device, and Readable Storage Medium for Obstacle Distance Determining Image

(71) Applicants: Lei PAN, Shenzhen, Guangdong (CN); Global Media Industry Group Co., Ltd., Shenzhen, Guangdong (CN)

(72) Inventor: Lei PAN, Shenzhen (CN)

(21) Appl. No.: 16/483,014

(22) PCT Filed: Aug. 1, 2017
(86) PCT No.: PCT/CN2017/095451

§ 371 Date: Aug. 1, 2019

(30) Foreign Application Priority Data
May 2, 2017 (CN) 2017 10299271.5

(51) Int. Cl. G06K 9/00; G06K 9/03

(52) U.S. Cl. CPC G06K 9/00805; G06K 2209/21; G06K 2209/23; G06K 9/03

(57) ABSTRACT

Provided are a generation method and apparatus, an electronic device for obstacle distance determining image, including: receiving first image sent by a first image collecting device, second image sent by a second image collecting device and distance information sent by a distance detector; performing wireframe analysis on the first image to obtain an initial outline of a target feature object, wherein the target feature object includes at least one window feature and an external scene feature visible through the window feature; performing an error adjustment on the initial outline according to the external scene feature visible through the window feature and the second image, so as to obtain a real outline of the target feature object; adjusting the size of the real outline of the target feature object; and overlapping the second image and the real outline to generate an obstacle distance determining image.

### CROSS-REFERENCE TO RELATED APPLICATION

The present application claims the priority of the Chinese patent application with the filing No. 2017102992715, filed May 2, 2017 with the State Intellectual Property Office, entitled “Generation Method and Apparatus for Obstacle Distance Determining Image”, which is incorporated herein by reference in its entirety.

### TECHNICAL FIELD

The present disclosure relates to the field of traffic safety, particularly to a method, apparatus, electronic device, and readable storage medium for generating obstacle distance determining image.

### BACKGROUND ART

During the process of automobile travelling, in order to expand the view behind the automobile, more and more automobiles are installed with a camera or cameras at the back of the automobile, then images taken by the camera(s) at the back of the automobile are displayed by a display screen inside the automobile, thus a driver can conveniently and intuitively see images behind the automobile.

However, although the driver sees the images behind the automobile through the display screen, the driver cannot figure out the position of automobiles or passersby in the images behind the automobile with respect to his/her own automobile, which may cause the driver to misjudge the position of an object behind the automobile, consequently accidents may occur.

How to address the above problem is the keypoint worthy of attention of a person skilled in the art.

### SUMMARY

In view of this, the present disclosure provides a method and apparatus for generating image to determine obstacle distance so as to enable drivers to more intuitively determine a distance between an object behind an automobile and the automobile through a display screen.

In a first aspect, the present disclosure provides a generation apparatus for obstacle distance determining image, where the generation apparatus includes:

an information receiving unit, configured to receive a first image in a viewing direction from an automobile cab towards a tail sent by a first image collecting apparatus and receive a second image in a viewing direction away from the tail outside the automobile sent by a second image collecting apparatus;

a wireframe analysis unit, configured to perform wireframe analysis on the first image, and thus acquire an initial outline of a target characteristic object in the viewing direction from the automobile cab towards the tail, where the target characteristic object includes at least one window feature and external scene features visible through the window feature;

an error adjustment unit, configured to perform error adjustment to the initial outline according to the external scene features visible through the window feature and the second image to obtain a real outline of the target characteristic object in the viewing direction from the automobile cab towards the tail; and

a generation unit for obstacle distance determining image, configured to overlap the second image and the real outline to generate an obstacle distance determining image.

In combination with the first aspect, an example of the present disclosure provides a first possible embodiment of the first aspect, where the automobile is configured with a distance detector configured to detect a distance between the automobile and the obstacle behind the tail, the information receiving unit is further configured to receive distance information between the automobile and the obstacle behind the tail sent by the distance detector, and the generation apparatus further includes:

a real outline adjustment unit, configured to adjust a size of the real outline of the target characteristic object according to a pre-stored automobile model, a height from the first image collecting apparatus to the ground, a distance from the first image collecting apparatus to a rear window , a rear left window, and a rear right window, a width of an automobile body, a length and a clear height of the rear window, a height from the rear window to the ground, a height from the second image collecting apparatus to the ground, a left-right viewing direction and an upward viewing direction of the second image collecting apparatus, a horizontal angle of installation of the second image collecting apparatus, and a distance information between the automobile and the obstacle behind the tail; and

the generation unit for obstacle distance determining image being configured to overlap the second image and the adjusted real outline of the target characteristic object to generate an image to determine obstacle distance.

In combination with the first aspect, an example of the present disclosure provides a second possible embodiment of the first aspect. The generation unit for obstacle distance determining image includes:

an overlapped image generation module, configured to overlap the second image and the adjusted real outline, to generate an overlapped image;

a minimum-distance obstacle selecting module, configured to select an obstacle at a minimum distance from the automobile according to the distance information; and

a state updating module, configured to select an overlapped area of the real outline and the obstacle at a minimum distance from the automobile, and update a display state of the real outline of the target characteristic object within the overlapped area to a display state different from the display state of the real outline of the target characteristic object outside the overlapped area, so that the display state of the real outline of the target characteristic object within the overlapped area is not the same as the display state of the real outline of the target characteristic object outside the overlapped area, where the display state refers to a color display state and/or a line shape display state.

In combination with the first aspect, an example of the present disclosure provides a third possible embodiment of the first aspect. The wireframe analysis unit includes:

an outline drawing module, configured to perform the wireframe analysis on the first image, and draw an outline of a scene characteristic object in the viewing direction from the automobile cab towards the tail; and

an outline extracting module for a target characteristic object, configured to extract the initial outline of the target characteristic object from the outline of the scene characteristic object in the viewing direction from the automobile cab towards the tail.

In combination with the first aspect, an example of the present disclosure provides a fourth possible embodiment of the first aspect. The error adjustment unit includes:

an image extracting module, configured to extract the external scene features visible through the window feature;

a correspondence establishment module, configured to establish a correspondence between an area characterizing an external scene feature in an image of the second image and the external scene feature; and

a solving module for solving offset and distortion, configured to solving offset and distortion of the initial outline according to the correspondence between the areas characterizing the external scene features in the image of the second image and the external scene features, and obtain the real outline.

In a second aspect, the present disclosure provides a generation method for obstacle distance determining image. The generation method includes the steps of:

receiving a first image in a viewing direction from an automobile cab towards a tail sent by a first image collecting apparatus and receiving a second image in a viewing direction away from the tail outside the automobile sent by a second image collecting apparatus;

performing wireframe analysis on the first image to acquire an initial outline of a target characteristic object in the viewing direction from the automobile cab towards the tail, where the target characteristic object includes at least one window feature and external scene features visible through the window feature;

performing error adjustment to the initial outline according to the external scene features visible through the window feature and the second image to obtain a real outline of the target characteristic object in the viewing direction from the automobile cab towards the tail; and

overlapping the second image and the real outline to generate an image for obstacle distance determination.

In combination with the second aspect, an example of the present disclosure provides a first possible embodiment of the second aspect. The automobile is configured with a distance detector configured to detect a distance between the automobile and the obstacle behind the tail, and after the step of performing error adjustment to the initial outline according to the external scene features visible through the window feature and the second image to obtain the real outline of the target characteristic object in the viewing direction from the automobile cab towards the tail, the generation method for obstacle distance determining image further includes:

receiving distance information between the automobile and the obstacle behind the tail obtained by the distance detector;

adjusting a size of the real outline of the target characteristic object according to a pre-stored automobile model, a height from the first image collecting apparatus to the ground, a distance from the first image collecting apparatus to a rear window, a distance from the first image collecting apparatus to a rear left window, a distance from the first image collecting apparatus to a rear right window, a width of an automobile body, a length and a clear height of the rear window, a height from a lower edge of the rear window to the ground, a height from the second image collecting apparatus to the ground, a left-right viewing direction and an upward viewing direction of the second image collecting apparatus, a horizontal angle of installation of the second image collecting apparatus, and the distance information; and

the step of overlapping the second image and the real outline to generate an image to determine obstacle distance includes:

overlapping the second image and the adjusted real outline of the target characteristic object to generate an image to determine obstacle distance.

In combination with the second aspect, an example of the present disclosure provides a second possible embodiment of the second aspect. The step of overlapping the second image and the real outline to generate an image to determine obstacle distance includes:

overlapping the second image and the real outline to generate an overlapped image;

selecting an obstacle at a minimum distance from the automobile according to the distance information; and

selecting an overlapped area of the real outline and the obstacle at a minimum distance from the automobile, and updating the display state of the real outline of the target characteristic object within the overlapped area to a display state different from a display state of the real outline of the target characteristic object outside the overlapped area, so that the display state of the real outline of the target characteristic object within the overlapped area is not the same as the display state of the real outline of the target characteristic object outside the overlapped area, where the display state including at least one of a color display state and a line shape display state.

In combination with the second aspect, an example of the present disclosure provides a third possible embodiment of the second aspect. The step of performing wireframe analysis on the first image to acquire an initial outline of a target characteristic object in a viewing direction from the automobile cab towards the tail includes:

performing the wireframe analysis on the first image, and drawing an outline of a scene characteristic object in the viewing direction from the automobile cab towards the tail; and

extracting the initial outline of the target characteristic object from the outline of the scene characteristic object in the viewing direction from the automobile cab towards the tail.

In combination with the second aspect, an example of the present disclosure provides a fourth possible embodiment of the second aspect. The step of performing error adjustment to the initial outline according to the external scene features visible through the window feature and the second image to obtain a real outline of the target characteristic object in the viewing direction from the automobile cab towards the tail includes:

extracting the external scene features visible through the window feature;

establishing a correspondence between an area characterizing an external scene feature in an image of the second image and the external scene feature; and

solving offset and distortion of the initial outline according to the correspondence between the areas characterizing the external scene features in the image of the second image and the external scene features, and obtain the real outline.

In a third aspect, the present disclosure provides an electronic device, including:

a memory;

a processor; and

a generation apparatus for obstacle distance determining image, the generation apparatus being mounted in the memory and including one or more software functional modules executed by the processor, the generation apparatus including:

an information receiving unit, configured to receive a first image in a viewing direction from an automobile cab towards a tail sent by a first image collecting apparatus and receive a second image in a viewing direction away from the tail outside the automobile sent by a second image collecting apparatus;

a wireframe analysis unit, configured to perform wireframe analysis on the first image to acquire an initial outline of a target characteristic object in the viewing direction from the automobile cab towards the tail, where the target characteristic object includes at least one window feature and external scene features visible through the window feature;

an error adjustment unit, configured to perform error adjustment to the initial outline according to the external scene features visible through the window feature and the second image to obtain a real outline of the target characteristic object in the viewing direction from the automobile cab towards the tail; and

a generation unit for obstacle distance determining image, configured to overlap the second image and the real outline to generate an image to determine obstacle distance.

In combination with the third aspect, an example of the present disclosure provides a first possible embodiment of the third aspect. The automobile is configured with a distance detector configured to detect a distance between the automobile and a obstacle behind the tail, the information receiving unit is further configured to receive distance information between the automobile and the obstacle behind the tail sent by the distance detector, and the generation apparatus for obstacle distance determining image further includes:

a real outline adjustment unit, configured to adjust a size of the real outline of the target characteristic object according to a pre-stored automobile model, a height from the first image collecting apparatus to the ground, a distance from the first image collecting apparatus to a rear window, a rear left window, and a rear right window, a width of an automobile body, a length and a clear height of the rear window, a height from the rear window to the ground, a height from the second image collecting apparatus to the ground, a left-right viewing direction and an upward viewing direction of the second image collecting apparatus, a horizontal angle of installation of the second image collecting apparatus, and the distance information between the automobile and the obstacle behind the tail; and

the generation unit for obstacle distance determining image, configured to overlap the second image and the adjusted real outline of the target characteristic object to generate an image to determine obstacle distance.

In combination with the third aspect, an example of the present disclosure provides a second possible embodiment of the third aspect. The generation unit for obstacle distance determining image includes:

an overlapped image generation module, configured to overlap the second image and the adjusted real outline to generate an overlapped image;

a minimum-distance obstacle selecting module, configured to select an obstacle at a minimum distance from the automobile according to the distance information; and

a state updating module, configured to select an overlapped area of the real outline and the obstacle at a minimum distance from the automobile, and update a display state of the real outline of the target characteristic object within the overlapped area to a display state different from the display state of the real outline of the target characteristic object outside the overlapped area, so that the display state of the real outline of the target characteristic object within the overlapped area is not the same as the display state of the real outline of the target characteristic object outside the overlapped area, where the display state refers to a color display state and/or a line shape display state.

In combination with the third aspect, an example of the present disclosure provides a third possible embodiment of the third aspect. The wireframe analysis unit includes:

an outline drawing module, configured to perform the wireframe analysis on the first image, and draw an outline of a scene characteristic object in the viewing direction from the automobile cab towards the tail; and

an outline extracting module for a target characteristic object, configured to extract the initial outline of the target characteristic object from the outline of the scene characteristic object in the viewing direction from the automobile cab towards the tail.

In combination with the third aspect, an example of the present disclosure provides a fourth possible embodiment of the third aspect. The error adjustment unit includes:

an image extracting module, configured to extract the external scene features visible through the window feature;

a correspondence establishment module, configured to establish a correspondence between an area characterizing an external scene feature in an image of the second image and the external scene feature; and

a solving module for solving offset and distortion, configured to solving offset and distortion of the initial outline according the correspondences between the areas characterizing the external scene features in the image of the second image and the external scene features, and obtain the real outline.

In a fourth aspect, the present disclosure provides a readable storage medium stored in a computer, including multiple instructions which are configured to realize the above generation method for obstacle distance determining image.

The present disclosure provides a generation method and apparatus for obstacle distance determining image. The apparatus can receive the first image in the viewing direction from the automobile cab towards the tail sent by the first image collecting apparatus and the second image in the viewing direction away from the tail outside the automobile sent by the second image collecting apparatus in real time, and perform the wireframe analysis on the first image, to acquire the initial outline of the target characteristic object in the viewing direction from the automobile cab towards the tail, and perform error adjustment to the initial outline according to the external scene features visible through the window feature and the second image, to obtain the real outline of the target characteristic object in the viewing direction from the automobile cab towards the tail, and finally overlap the second image and the real outline, to generate the obstacle distance determining image. Since the obstacle distance determining image is generated on the basis of the first image and the second image in the present disclosure, it enables the user to determine an approximate distance between the obstacle behind the automobile and the automobile by observing the obstacle distance determining image so as to avoid occurrence of accidents. In addition, the size of the outline can be varied with the distance between the obstacle and the automobile, which enables the user to more accurately determine the distance between the obstacle and the automobile. Moreover, according to the generation method and apparatus for obstacle distance determining image provided in the present disclosure, the real outline is upon error adjustment, therefore, the accuracy of the generation method and apparatus for obstacle distance determining image provided in the present disclosure is quite high, which enables the user to more accurately determine the distance between the obstacle behind the automobile and the automobile.

### BRIEF DESCRIPTION OF DRAWINGS

In order to more clearly illustrate technical solutions of examples of the present disclosure, figures related to the examples will be illustrated briefly below. It should be understood that the figures below merely show some examples of the present disclosure, and therefore should not be considered as limiting the scope. A person ordinarily skilled in the art still can obtain other relevant figures according to these figures, without paying inventive effort.

FIG. 1 is a schematic view of interaction of a server with a first image collecting apparatus, a second image collecting apparatus, a distance sensor, and a display screen provided in an example of the present disclosure.

FIG. 2 is a block diagram of a generation apparatus for obstacle distance determining image provided in an example of the present disclosure.

FIG. 3 is a functional module diagram of a generation apparatus for obstacle distance determining image provided in an example of the present disclosure.

FIG. 4 is a schematic view of a first type of a first image provided in an example of the present disclosure.

FIG. 5 is a schematic view of a second type of the first image provided in an example of the present disclosure.

FIG. 6 is a schematic view of a third type of the first image provided in an example of the present disclosure.

FIG. 7 is a schematic view of a second image provided in an example of the present disclosure.

FIG. 8 is a functional module diagram of a wireframe analysis unit provided in an example of the present disclosure.

FIG. 9 is a schematic view of an approximate outline provided in an example of the present disclosure.

FIG. 10 is a functional module diagram of an error adjustment unit provided in an example of the present disclosure.

FIG. 11 is a schematic view of establishment of correspondence provided in an example of the present disclosure.

FIG. 12 is a schematic view of a real outline provided in an example of the present disclosure.

FIG. 13 is a functional module diagram of a generation unit for obstacle distance determining image provided in an example of the present disclosure.

FIG. 14 is a schematic view of an overlapped image provided in an example of the present disclosure.

FIG. 15 is a schematic view of an obstacle distance determining image provided in an example of the present disclosure.

FIG. 16 is a flow chart of a generation method for obstacle distance determining image provided in an example of the present disclosure.

FIG. 17 is a flow chart of acquiring an initial outline provided in an example of the present disclosure.

FIG. 18 is a flow chart of acquiring the real outline provided in an example of the present disclosure.

FIG. 19 is a flow chart of generating an obstacle distance determining image provided in an example of the present disclosure.

Reference signs: 12-memory; 13-memory controller; 14-processor; 15-peripheral interface; 100-generation apparatus for obstacle distance determining image; 110-information receiving unit; 120-wireframe analysis unit; 121-outline extracting module for scene characteristic object; 122-outline extracting module for target characteristic object; 130-error adjustment unit; 131-image extracting module; 132-correspondence establishment module; 133-solving module for solving offset and distortion; 140-real outline adjustment unit; 150-generation unit for obstacle distance determining image; 151-overlapped image generation module; 152-minimum-distance obstacle selecting module; 153-state updating module; 200-server; 210-first image collecting apparatus; 220-second image collecting apparatus; 230-distance detector; 240-display screen.

### DETAILED DESCRIPTION OF EMBODIMENTS

Technical solutions of the examples of the present disclosure will be described clearly and comprehensively in conjunction with the figures of the examples of the present disclosure below. Apparently, those illustrated examples are merely some but not all of the examples of the present disclosure. Generally, components in the examples of the present disclosure described and shown in the figures herein can be arranged and designed in different configurations. Therefore, the detailed description below of the examples of the present disclosure provided in the figures is not intended to limit the scope of protection of the present disclosure, but merely represents chosen examples of the present disclosure. Based on the examples of the present disclosure, all the other examples, which a person ordinarily skilled in the art obtains without paying inventive effort, fall within the scope of protection of the present disclosure.

It should be noted that similar reference signs and letters represent similar items in the following figures, therefore, once a certain item is defined in one figure, it is not needed to be further defined or explained in subsequent figures. Besides, in the description of the present disclosure, terms such as “first” and “second” are merely for descriptive purpose, but should not be construed as indicating or implying relative importance.

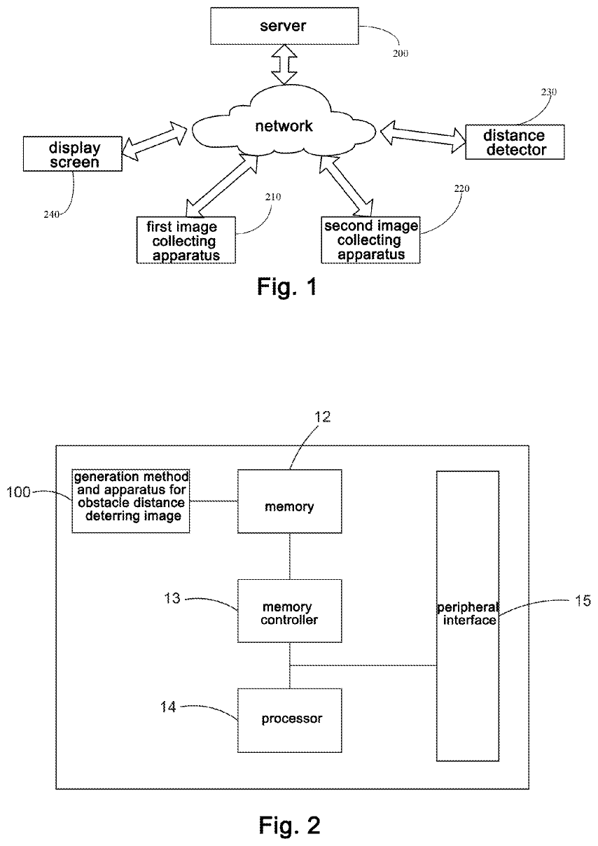

A generation method and apparatus for obstacle distance determining image provided in preferred examples of the present disclosure can be applied to an application circumstance as shown in FIG. 1. As shown in FIG. 1, a first image collecting apparatus 210, a second image collecting apparatus 220, a distance detector 230, a display screen 240, and a server 200 are located in a network, through which network the first image collecting apparatus 210, the second image collecting apparatus 220, the distance detector 230, the display screen 240, and the server 200 can perform data interaction. In the examples of the present disclosure, the server 200 is selected from, but not limited to, a network server, a database server, a cloud server, etc.

As shown in FIG. 2, it is a functional module diagram of the server 200 provided in the present disclosure. The server 200 includes a generation apparatus 100 for obstacle distance determining image, a memory 12, a memory controller 13, a processor 14, and a peripheral interface 15.

The respective elements of the memory 12, the memory controller 13, the processor 14, and the peripheral interface 15 are directly or indirectly electrically connected to each other so as to realize transmission or interaction of data. For example, these elements can realize the electrical connection with each other through one or more communication buses or signal lines. The generation apparatus 100 includes at least one software functional module which can be stored in the memory 12 or built-in in an operating system (OS) of the server 200 in a form of software or firmware. The processor 14 is used to execute an executable module stored in the memory 12, for example, a computer program or the software functional module included in the generation apparatus 100 for obstacle distance determining image.

Thereinto, the memory 12 is selected from, but not limited to, Random Access Memory (RAM), Read Only Memory (ROM), Programmable Read-Only Memory (PROM), Erasable Programmable Read-Only Memory (EPROM), Electric Erasable Programmable Read-Only Memory (EEPROM), etc. Thereinto, the memory 12 is used to store a program, the processor 14 executes the program after receiving an executive instruction, and the method executed by the server 200 defined by the flow process disclosed in any of the preceding examples of the present disclosure can be applied to the processor 14, or implemented by the processor 14.

The processor 14 can be an integrated circuit chip, with the capacity of processing signals. The above processor 14 can be a general-purpose processor, including Central Processing Unit (referred to as “CPU” for short), Network Processor (referred to as “NP” for short),etc.; the processor also can be Digital Signal Processor (DSP), Application-Specific Integrated Circuit (ASIC), Field-Programmable Gate Array (FPGA) or other programmable logic devices, discrete gates or transistor logic devices, and discrete hardware components, which can realize or execute various methods, steps, and logic block diagrams disclosed in the examples of the present disclosure. The general-purpose processor can be a microprocessor or the processor 14 also can be any conventional processor and the like.

The peripheral interface 15 couples various input/output means to the processor 14 and the memory 12. In some examples, the peripheral interface 15, the processor 14, and the memory controller 13 can be implemented in a single chip. In some other examples, they can be implemented in separate chips.

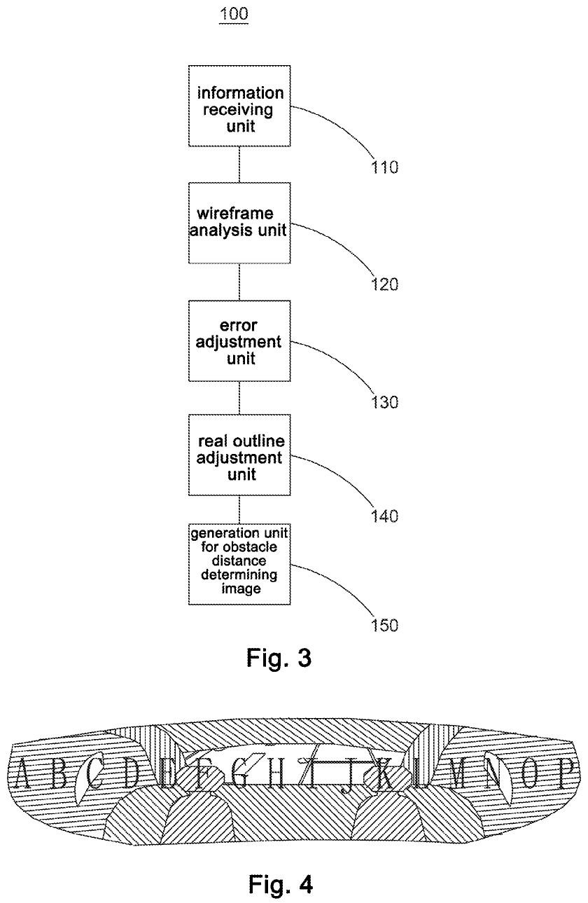

Referring to FIG. 3, an example of the present disclosure provides a generation apparatus 100 for obstacle distance determining image, and the automobile is configured with a distance detector for detecting a distance between the automobile and an obstacle behind a tail. The generation apparatus 100 includes an information receiving unit 110, a wireframe analysis unit 120, an error adjustment unit 130, a real outline adjustment unit 140, and a generation unit 150 for obstacle distance determining image.

The information receiving unit 110 is configured to receive a first image in a viewing direction from an automobile cab towards the tail sent by the first image collecting apparatus 210, a second image in a viewing direction away from the tail outside the automobile sent by the second image collecting apparatus 220, and distance information between the automobile and the obstacle behind the tail.

In the present example, the first image collecting apparatus 210, the second image collecting apparatus 220, and the distance detector 230 are all in communication connection with the server 200, where the first image collecting apparatus 210 can be a cellphone, the second image collecting apparatus 220 can be a camera, the first image collecting apparatus 210 can take a first image in the viewing direction from the automobile cab towards the tail, and send the first image to the information receiving unit 110; the second image collecting apparatus 220 can take a second image in the viewing direction away from the tail outside the automobile, and send the second image to the information receiving unit 110. Of course, in further examples, the first image collecting apparatus 210 and the second image collecting apparatus 220 also can be other image collecting devices, for example, cameras, and no restriction is made thereto in the present example. In the present example, the distance detector 230 can be a radar, and this radar can measure distance between the automobile and the obstacle behind the tail, and send the distance information to the information receiving unit 110. Of course, in further examples, the distance detector 230 also can be other devices, for example, infrared detector, and no restriction is made thereto in the present example.

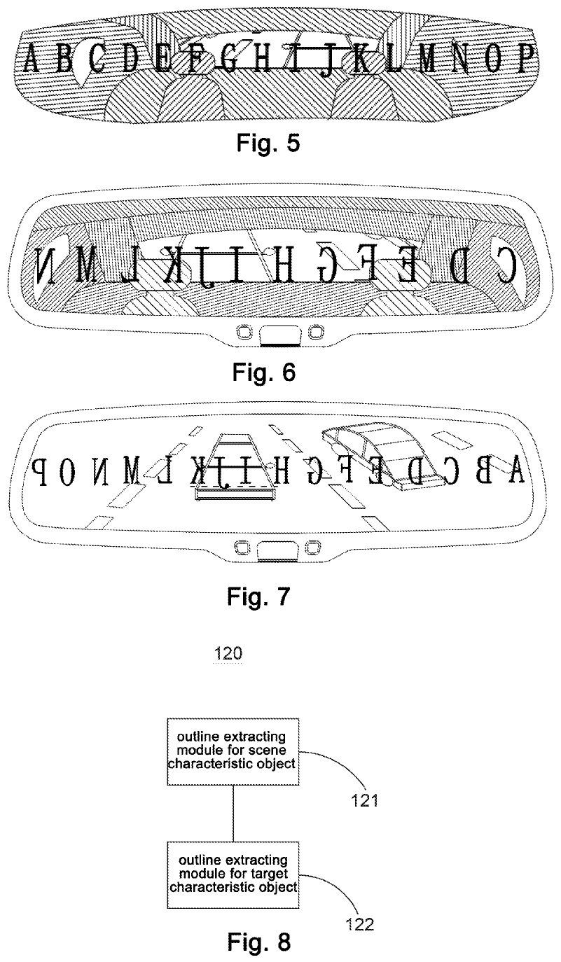

Below an example is recited for illustration. For example, a wall with a very large area is located 15 meters behind the automobile, and extremely large letters A, B, C, D, E, F, G, H, I, J, K, L, M, and N are written on the wall. In order to obtain an initial outline of a target characteristic object, the first image must include an image of the target characteristic object, and the image of the target characteristic object includes, but not limited to, an image with two rear seat headrests, a rear window, a rear right window, and a rear left window. In view of this, the first image needs to be taken from a viewing direction from the automobile cab towards the tail. In the present example, there may be three ways of taking the first image from the viewing direction from the automobile cab towards the tail. As a first embodiment of the present example, the first image collecting apparatus 210 is mounted at an interior rearview mirror, the first image is taken from the interior rearview mirror towards the tail. The first image taken is as shown in FIG. 4. It can be seen from the figure that some external scenes behind the automobile can be seen through the rear window, the rear right window, and the rear left window respectively, that is, F, G, H, I, J, and K can be seen through the rear window, C can be seen through the rear right window, and N can be seen through the rear left window. Referring to FIG. 5, in a second embodiment of the present example, the first image collecting apparatus 210 is mounted in a position of a headrest of a driver's seat, and the first image is taken from a viewing direction from the position of the headrest of the driver's seat to the tail. Referring to FIG. 6, in a third embodiment of the present example, the first image collecting apparatus 210 is mounted in the position of the headrest of the driver's seat, and the first image is taken from a viewing direction from the position of the headrest of the driver's seat towards the interior rearview mirror. The second embodiment is used in the present example. Of course, in other examples, in order to meet requirements of different drivers, other embodiments also can be used. Referring to FIG. 7, the second image collecting apparatus 220 is mounted at a tail portion of the automobile, and the second image is taken from the viewing direction from the tail portion of the automobile away from the tail, and images of all areas behind the automobile can be seen through the second image collecting apparatus 220, that is, A, B, C, D, E, F, G, H, I, J, K, L, M, and N can be seen through the second image collecting apparatus 220.

The wireframe analysis unit 120 is configured to perform wireframe analysis on the first image to acquire the initial outline of the target characteristic object in the viewing direction from the automobile cab towards the tail, where the target characteristic object includes at least one window feature and external scene features visible through the window feature. Referring to FIG. 8, the wireframe analysis unit 120 specifically includes an outline extracting module 121 for scene characteristic object and an outline extracting module 122 for target characteristic object.

The outline extracting module 121 for scene characteristic object is configured to perform the wireframe analysis on the first image, and extract an outline of the scene characteristic object in the viewing direction from the automobile cab towards the tail.

Thereinto, the scene characteristic object includes all objects seen in the viewing direction from the automobile cab towards the tail, for example, a roof, rear seats, the rear window, the rear right window, the rear left window, rear doors, and so on, and after the first image is acquired, the outline extracting module for scene characteristic object will perform the wireframe analysis on the objects in the image, so as to extract the wireframes of all objects in the first image, i.e. extract the outlines of the scene characteristic objects in the first image.

The outline extracting module 122 for target characteristic object is configured to extract the initial outline of the target characteristic object from the outlines of the scene characteristic objects in the viewing direction from the automobile cab towards the tail.

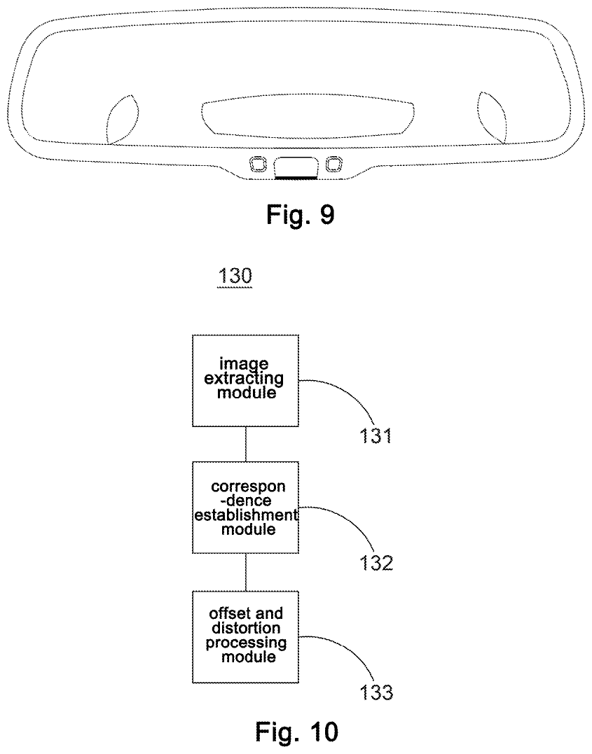

After the outline of the scene characteristic object in the first image is extracted, since there are relatively a lot of scene characteristic objects in the first image, there are also relatively a lot of extracted outlines of the scene characteristic objects in the first image, but excessive outlines are not conducive to the driver to determine the distance of obstacle according to the generated obstacle distance determining image. Therefore, in the present example, in order to facilitate the driver's observation, the initial outline only includes the headrests of the rear seat, the rear window, the rear right window, and the rear left window, i.e. in the present example, the target characteristic objects are the headrests of the rear seat, the rear window, the rear right window, and the rear left window. The outline extracting module 122 for target characteristic object can screen the outlines of the scene characteristic objects in the first image so as to extract the initial outlines of the target characteristic objects. Moreover, the outline extracting module 122 for target characteristic object can further extract a transparent image of an approximate outline of the whole automobile body, and the extracted transparent image is as shown in FIG. 9.

Since during actual use, the first image can be taken from the position of the driver in the automobile, and the second image can be taken by a camera mounted at the back of the automobile, positions of sources of the first image and the second image are different. Moreover, as the distance between the obstacle behind the automobile and the automobile varies, the outline images observed by the driver are also varied. For example, when there is no obstacle behind the automobile, and the automobile travels at a high speed, the driver will observe an image about 50 meters behind the automobile through the display screen 240. When the automobile travels at a low speed or there is an obstacle 3 meters behind the automobile, the driver will mainly observe an image 3 meters behind the automobile through the display screen 240. The driver usually observes the image behind the automobile through the outline on the display screen 240, and as the distance between the automobile and the obstacle varies, the size, shape, and position of the initial outline of the target characteristic object are also varied. However, during the process of changes of the outline, when three areas of the first image and the second image overlap, the outline position will be offset, and the shape is likely to be distorted to a certain extent. In view of this, in order to reduce the occurrence of errors, in the present example, the error adjustment unit 130 needs to be used to perform the error adjustment to the initial outline of the target characteristic object. Referring to FIG. 10, the error adjustment unit 130 includes an image extracting module 131, a correspondence establishing module 132, and a solving module 133 for solving offset and distortion.

The image extracting module 131 is configured to extract external scene features visible through the window feature.

In the present example, since the first image includes the rear window, the rear right window, and the rear left window, and the rear window, the rear right window, and the rear left window can be all transparent, the external scene features outside the windows can be extracted through the windows of the rear window, the rear right window, and the rear left window, and the external scene features include features such as road surface or obstacle, i.e. the image extracting module 131 can extract the images of the external scene features of three areas outside the rear window, outside the rear right window, and outside the rear left window;

The correspondence establishment module 132 is configured to establish correspondence between the areas characterizing the external scene features in the image of the second image and the external scene features.

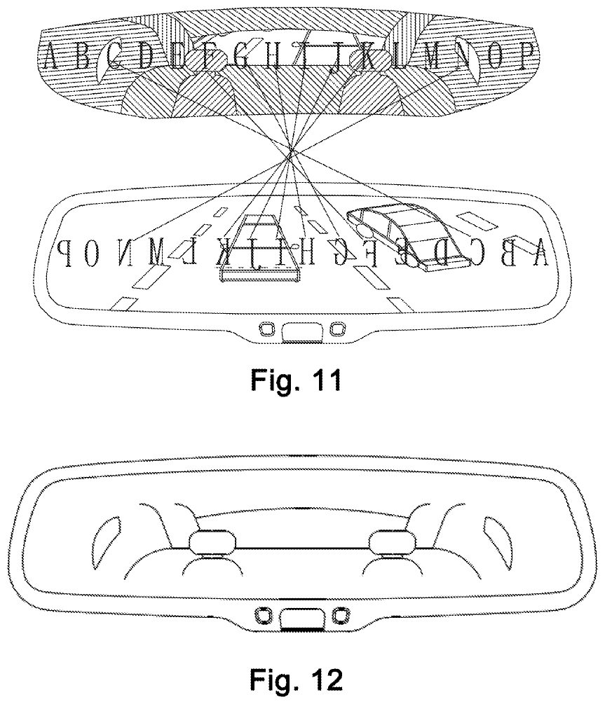

Since the image collected by the second image collecting apparatus 220 is the whole image behind the tail, the image collected by the second image collecting apparatus 220 includes images of the external scene features of the three areas extracted by the image extracting module 131, and the images of the external scene features includes the images of the road surface or the obstacle, i.e., the second image collected by the second image collecting apparatus 220 and the images of the external scene features of the three areas extracted by the image extracting module 131 have three same areas, i.e., F, G, H, I, J, and K which can be seen through the rear window, C which can be seen through the rear right window, and N which can be seen through the rear left window. Images of the three same areas of the second image collected by the second image collecting apparatus 220 and the images of the external scene features of the three areas extracted by the image extracting module 131 can be found out upon comparison and analysis, and the correspondence can be established between the areas characterizing the external scene features in the image of the second image and the external scene features, the correspondence characterizing the positional relationship between the image in the first image and the image in the second image. That is, contents and boundary ranges of the three windows in the first image are processed to overlap completely. Then according to a result of overlapping the three windows, the outlines of the objects inside the automobile such as the headrests of the rear seats and the windows are subjected to corresponding distortion and offset, and a schematic view of the processing procedures is as shown in FIG. 11.

The solving module 133 is configured to solve the offset and distortion of the initial outline according to the established correspondence and obtain the real outline.

Since the correspondence characterizing the positional relationship between the image in the first image and the image in the second image has been established, and the initial outline is provided by the first image, the correspondence is also configured as a positional correspondence between the initial outline and the image in the second image. Through the correspondence, the solving module 133 can solve the offset and distortion of the initial outline, i.e., the solving module 133 can process the initial outline in position and shape so as to obtain an appropriate real outline. Since the initial outline is processed in position and shape, the accuracy of the real outline is higher, which is more favorable for the driver to determine the obstacle behind the automobile during the driving process, so as to avoid occurrence of accidents. Moreover, the solving module 133 will further delete some areas outside the outline according to the situation to obtain a real outline as shown in FIG. 12.

The real outline adjustment unit 140 is configured to adjust the size of the real outline of the target characteristic object according a pre-stored automobile model, a height from the first image collecting apparatus 210 to the ground, a distance from the first image collecting apparatus 210 to the rear window, the rear left window, and the rear right window, a width of the automobile body, a length and a clear height of the rear window, a height from a lower edge of the rear window to the ground, a height from the second image collecting apparatus 220 to the ground, a left-right viewing direction and an upward viewing direction of the second image collecting apparatus 220, a horizontal angle of installation of the second image collecting apparatus 220, and the distance information.

In the present example, in order to enable the driver to more intuitively estimate the distance between the automobile and the obstacle, the initial outline of the target characteristic object can be provided as an outline with variable shape and position, for example, optionally, when the obstacle is relatively far away from the automobile, the initial outline of the target characteristic object is relatively small; when the obstacle is relatively near to the automobile, the initial outline of the target characteristic object is relatively big. In order to realize the above effects, in the present example, the memory 12 is pre-stored with data such as the automobile model, the height from the first image collecting apparatus 210 to the ground, the distances from the first image collecting apparatus 210 to the rear window, the rear left window, and the rear right window, the width of the automobile body, the length and the clear height of the rear window, the height from the rear window to the ground, the height from the second image collecting apparatus 220 to the ground, the left-right viewing direction and the upward viewing direction of the second image collecting apparatus 220 at the back of the automobile, and the horizontal angle of installation of the second image collecting apparatus 220 at the back of the automobile. By gathering the above data, the sizes and the positions of the outlines corresponding to different distances behind the automobile can be obtained. That is, a correspondence between the distance information and the real outline of the target characteristic object is calculated on the basis of the above data, and the correspondence between the distance information and the real outline of the target characteristic object is pre-stored. It can be seen from the correspondence that when the distance between the automobile and the obstacle is a fixed value, the shape and the position of the real outline of the corresponding target characteristic object have a unique value corresponding thereto. Moreover, the distance information between the automobile and the obstacle can be known through the distance detector 230, so that the shape and position information of the real outline of the target characteristic object in the present example can be obtained.

It should be indicated that in the present example, the adjustment of the outline is the adjustment of the real outline, however, during practical use, the real outline may not need to be adjusted, only the initial outline is required to be adjusted, and the same effect still can be achieved. No restriction is made thereto in the present example.

For example, when there is a child behind the automobile, and the distance between the child and the automobile is 30 m, the length of the outline is 5 cm; when the child walks towards the direction of the automobile, and his/her distance with the automobile is changed to 10 m, the length of the outline at this time is changed to 10 cm, indicating that the child is quite close to the automobile. The user can determine an approximate distance between the child and the automobile at this time by the means of the length of the outline on the display screen 240, i.e., the longer the outline, the smaller the distance between the child and the automobile. Thus, the driver can be prevented from hitting the child during the driving process, so as to avoid the occurrence of accidents.

The generation unit 150 for obstacle distance determining image is configured to overlap the second image and the adjusted real outline of the target characteristic object to generate the obstacle distance determining image.

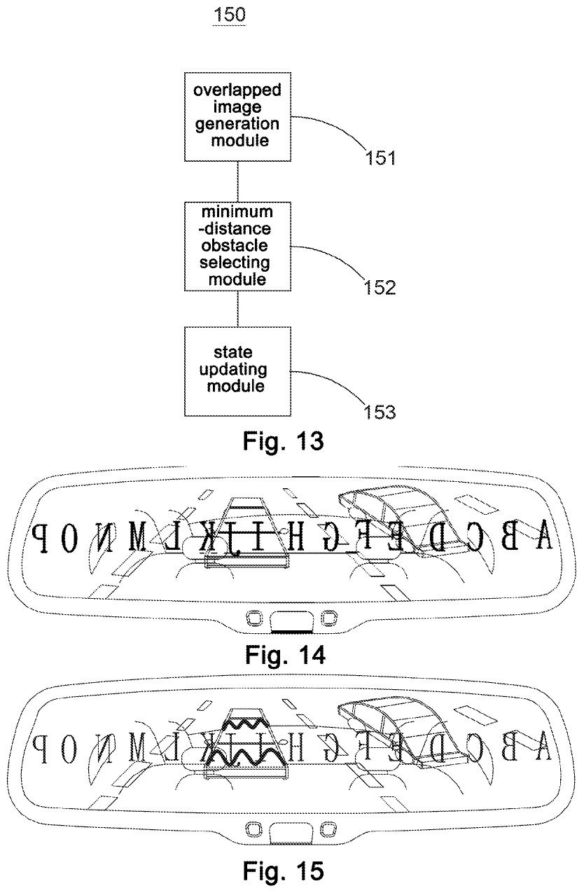

After the adjusted real outline of the target characteristic object is obtained, the real outline should be overlapped with the second image, so that the user can intuitively see the obstacle distance determining image, thereby estimating the distance between the tail and the obstacle, avoiding the occurrence of accidents. Referring to FIG. 13, the generation unit 150 for obstacle distance determination includes: an overlapped image generation module 151, a minimum-distance obstacle selecting module 152, and a state updating module 153.

The overlapped image generation module 151 is configured to overlap the second image and the real outline, and the overlapped image is as shown in FIG. 14.

The minimum-distance obstacle selecting module 152 is configured to select an obstacle at the minimum distance from the automobile.

In order to make the driver know that the outline displayed in front indicates which distance is the object away from the automobile, the outlines can be marked with different colors. Specifically, when the information receiving unit 110 receives the obstacle distance detected by the distance detector 230, the minimum-distance obstacle selecting module 152 can select an obstacle whose distance is the minimum to the automobile, i.e., an obstacle which most likely has a traffic accident with the automobile.

The state updating module 153 is configured to select an overlapped area of the real outline and the obstacle at the minimum distance from the automobile, and update a display state of the real outline of the target characteristic object located in the overlapped area to a display state different from that of the real outline of the target characteristic object located outside the overlapped area, so that the display state of the real outline of the target characteristic object located in the overlapped area is not the same as that of the real outline of the target characteristic object located outside the overlapped area. The display state is color display state and/or line shape display state.

Referring to FIG. 15, after selecting the obstacle at the minimum distance from the automobile, an overlapped area of this obstacle with the real outline can be selected, the state updating module 153 can generate an instruction configured to mark the real outline within the overlapped area with a first color, and can generate another instruction configured to mark the real outline outside the overlapped area with a second color. Alternatively, the state updating module 153 can generate an instruction configured to mark the real outline within the overlapped area with a first shape, and can generate another instruction configured to mark the real outline outside the overlapped area with a second shape. Thus, the display state of the real outline of the target characteristic object within the overlapped area and the display state of the real outline of the target characteristic object outside the overlapped area are different. Consequently, according to the different colors and/or different shapes of the real outlines, the driver can know that which particular obstacle behind the automobile is taken as the reference by the size of the outline at the moment, that is, the driver is able to intuitively see the obstacle nearest to the automobile, and estimate the distance between the automobile and the obstacle through the size of the real outline at the moment, so as to effectively avoid occurrence of accidents.

It should be indicated that in the present example, the state updating module 153 can mark the real outline located in the overlapped area with a red color, and mark the real outline located outside the overlapped area with a blue color, and/or can mark the real outline located in the overlapped area with a wavy shape, and mark the real outline located outside the overlapped area with a shape of straight line. However, in further examples, the state updating module 153 also can mark the real outline within the overlapped area and the real outline outside the overlapped area with other colors and/or shapes, and no restriction is made thereto in the present example.

It also should be indicated that in the present example, an electronic device with the generation apparatus 100 can be mounted inside the automobile, and the first image and the second image are processed by the generation apparatus 100 of the electronic device mounted inside the automobile, so as to obtain the obstacle distance determining image with the real outlines. However, in practical use, the obstacle distance determining image also can be generated in other manners, for example, data concerning the shapes of many types of automobiles can be collected in a cloud server, and 40 pictures with outline of different distance, from 1 m to 40 m, of relevant automobile models are calculated in advance. The driver can send the first image, the second image, and the information of the size of the automobile model to the cloud server, the cloud server will automatically select 40 pictures with outline of different distance which are applicable to this automobile according to the pre-collected information of the real outlines of the automobile models, the received first image and second image, and send the same to the generation apparatus 100. The generation apparatus 100 will store the data of the 40 pictures. When the distance detector at the back of the automobile detects a change in distance between the obstacle and the automobile, it will automatically select a real outline of the corresponding distance, and mark the real outline of the area where the obstacle with the minimum distance is located with a red color and/or a wavy shape, so as to remind the driver that which obstacle is taken as the reference by the outlines at the moment. By estimating the distance between the automobile and the obstacle according to the size of the outline at the moment, occurrence of accidents is effectively avoided.

### SECOND EXAMPLE

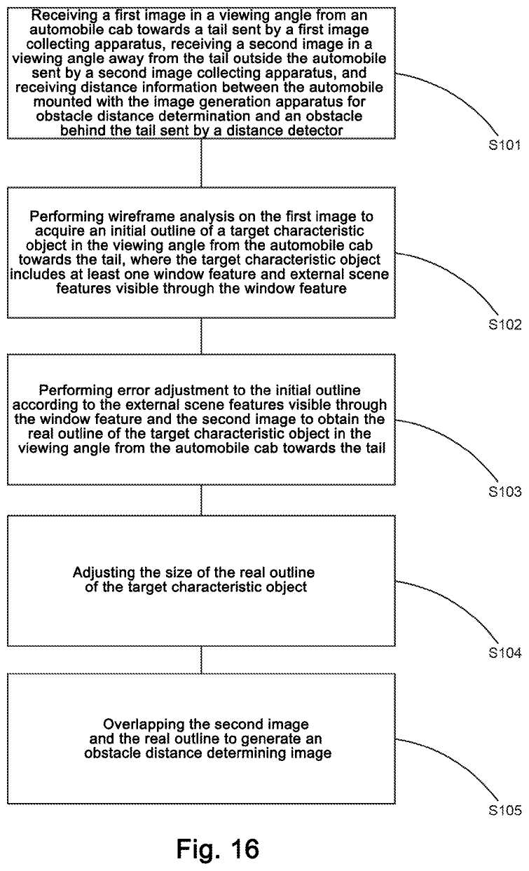

An example of the present disclosure further provides a generation method for obstacle distance determining image. It should be indicated that the generation method for obstacle distance determining image provided in the present example has the same basic principle and resulting technical effect as the above example. For the sake of conciseness, reference can be made to corresponding contents in the above example for parts which are not mentioned in the present example. Referring to FIG. 16, the generation method for obstacle distance determining image includes the following steps.

Step S101, receiving a first image in a viewing direction from an automobile cab towards a tail sent by a first image collecting apparatus 210, receiving a second image in a viewing direction away from the tail outside the automobile sent by a second image collecting apparatus 220, and receiving distance information between the automobile and an obstacle behind the tail sent by a distance detector 230.

It can be understood that Step S101 can be executed by an information receiving unit 110.

Step S102, performing wireframe analysis on the first image to acquire an initial outline of the target characteristic object in the viewing direction from the automobile cab towards the tail, where the target characteristic object includes at least one window feature and external scene features visible through the window feature.

It can be understood that Step S102 can be executed by a wireframe analysis unit 120.

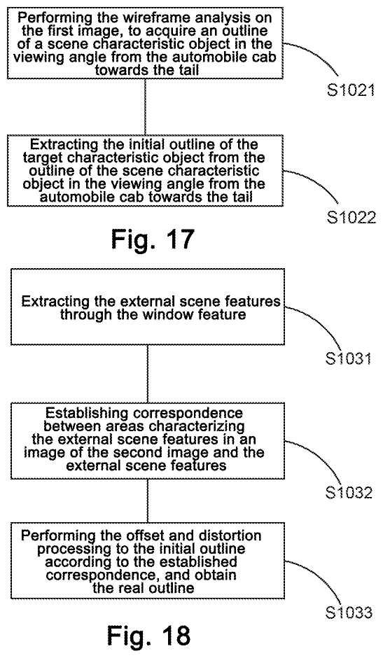

Referring to FIG. 17, the step of performing wireframe analysis on the first image to acquire an initial outline of the target characteristic object in the viewing direction from the automobile cab towards the tail, where the target characteristic object includes at least one window feature and external scene features visible through the window feature, includes the following sub-steps.

Sub-step S1021, performing the wireframe analysis on the first image, to acquire an outline of a scene characteristic object in the viewing direction from the automobile cab towards the tail.

It can be understood that Sub-step S1021 can be executed by an outline extracting module 121 for scene feature.

Sub-step S1022, extracting the initial outline of the target characteristic object from the outline of the scene characteristic object in the viewing direction from the automobile cab towards the tail.

It can be understood that Sub-step S1022 can be executed by an outline extracting module 122 for target feature.

Step S103, performing error adjustment to the initial outline according to the external scene features visible through the window feature and the second image to obtain the real outline of the target characteristic object in the viewing direction from the automobile cab towards the tail.

It can be understood that Step S103 can be executed by an error adjustment unit 130.

Referring to FIG. 18, the step of performing error adjustment to the initial outline according to the external scene features visible through the window feature and the second image to obtain the real outline of the target characteristic object in the viewing direction from the automobile cab towards the tail includes the following sub-steps.

Sub-step S1031, extracting the external scene features visible through the window feature.

It can be understood that Sub-step S1031 can be executed by an image extracting module 131.

Sub-step S1032, establishing correspondence between the areas characterizing the external scene features in the image of the second image and the external scene features.

It can be understood that Sub-step S1032 can be implemented by a correspondence establishment module 132.

Sub-step S1033, solving the offset and distortion of the initial outline according the established correspondence, and obtain the real outline.

It can be understood that Sub-step S1033 can be executed by a solving module 133.

Step S104, adjusting the size of the initial outline of the target characteristic object according a pre-stored automobile model, a height from the first image collecting apparatus 210 to the ground, distance from the first image collecting apparatus 210 to a rear window, a rear left window, and a rear right window, a width of an automobile body, a length and a clear height of the rear window, a height from the rear window to the ground, a height from the second image collecting apparatus 220 to the ground, a left-right viewing direction and an upward viewing direction of the second image collecting apparatus 220, a horizontal angle of installation of the second image collecting apparatus 220, and the distance information between the automobile and the obstacle behind the tail.

It can be understood that Step S104 can be implemented by a real outline adjustment unit 140.

Step S105, overlapping the second image and the real outline to generate an obstacle distance determining image.

It can be understood that Step S105 can be implemented by a generation unit 150 for obstacle distance determining image.

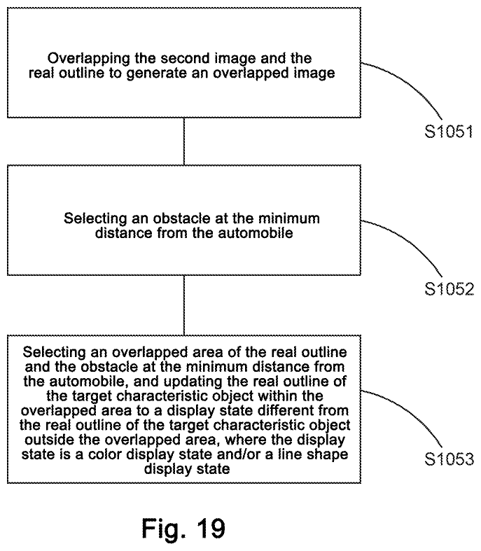

Referring to FIG. 19, the step of overlapping the second image and the real outline to generate an obstacle distance determining image includes the following sub-steps.

Sub-step S1051, overlapping the second image and the real outline to generate an overlapped image.

It can be understood that Sub-step S1051 can be implemented by an overlapped image generation module 151.

Sub-step S1052, selecting an obstacle at the minimum distance from the automobile.

It can be understood that Sub-step S1052 can be implemented by a minimum-distance obstacle selecting module 152.

Sub-step S1053, selecting an overlapped area of the real outline and the obstacle at the minimum distance from the automobile, and updating the real outline of the target characteristic object within the overlapped area to a display state different from that of the target characteristic object outside the overlapped area, where the display state is a color display state and/or a line shape display state.

It can be understood that Sub-step S1053 can be implemented by a color marking module 153.

To sum up, the present disclosure provides a generation method and apparatus for obstacle distance determining image, which can receive the first image in the viewing direction from the automobile cab towards the tail sent by the first image collecting apparatus and the second image in the viewing direction away from the tail outside the automobile sent by the second image collecting apparatus in real time, and perform the wireframe analysis on the first image, to acquire the initial outline of the target characteristic object in the viewing direction from the automobile cab towards the tail, and perform error adjustment to the initial outline according the external scene features visible through the window feature and the second image, to obtain the real outline of the target characteristic object in the viewing direction from the automobile cab towards the tail, and finally overlap the second image and the real outline, to generate an obstacle distance determining image. The user can determine the approximate distance between the obstacle behind the automobile and the automobile by observing the obstacle distance determining image so as to avoid occurrence of accidents. Moreover, since the real outline is generated upon the error adjustment in the generation method and apparatus provided in the present disclosure, the accuracy of the generation method and apparatus provided in the present disclosure is quite high, which enables the user to more accurately determine the distance between the obstacle behind the automobile and the automobile.

In the several examples provided in the present disclosure, it should be understood that the apparatus and method disclosed also can be implemented in other ways. The above-mentioned apparatus examples are merely illustrative, for example, the flow charts and the block diagrams in the accompanying drawings show possibly implemented system architectures, functions, and operations of the apparatus, methods, and computer programs product of several examples according to the present disclosure. In this regard, each block in the flow charts or the block diagrams can represent a part of one module, program segment or code, and the part of the module, program segment or code contains one or more executable instructions for implementing the stipulated logic function. It also should be noted that in some alternative implementations, the functions indicated in the blocks also can take place in an order different from that marked in the figures. For example, two sequential blocks actually can be executed substantially in parallel, and they sometimes also can be executed in a reverse order, which depends upon the related function. It also should be noted that each block of the block diagrams and/or the flow charts, and combination of the blocks in the block diagrams and/or the flow charts can be implemented by a dedicated hardware-based system executing a required function or action, or can be implemented by a combination of special-purpose hardware and computer instructions.

Besides, the various functional modules in various examples of the present disclosure can be integrated together to form one independent portion, or also can exist independently, or two or more modules also can be integrated to form one independent part.

When the function is realized in a form of software functional module and is sold or used as an individual product, it can be stored in one computer readable storage medium. Based on such understanding, the technical solution of the present disclosure essentially or the part making contribution to the prior art or all or part of this technical solution can be embodied in a form of software product, and this computer software product is stored in one storage medium, including several instructions used to make one computer device (which can be a personal computer, a sever or a network device etc.) execute all or part of the steps of the methods of each example of the present disclosure. The aforementioned storage medium includes various media that can store program codes, such as U disk, mobile hard disk, Read-Only Memory (ROM), Random Access Memory (RAM), diskette or compact disk and so on. It should be indicated that in the text relational terms such as “first” and “second” are merely used to distinguish one entity or operation from another entity or operation, but do not necessarily require or suggest any such actual relation or order among these entities or operations. Moreover, terms “include”, “contain” or any other variants thereof are intended to be non-exclusive, so that a process, method, article or device including a series of elements not only includes those elements, but also includes other elements which are not specified, or further includes elements inherent to such process, method, article, or device. In cases where there are no more restrictions, an element defined with the phrasing “including one . . . ” does not exclude that the process, method, article or device including the element further includes a further same element.

The above is merely preferable examples of the present disclosure and not intended to limit the present disclosure. For one skilled in the art, various modifications and changes may be made to the present disclosure. Any modifications, equivalent replacements, improvements and so on, without departing from the spirit and principle of the present disclosure, should be covered by the scope of protection of the present disclosure. It should be noted that similar reference signs and letters represent similar items in the following figures, therefore, once a certain item is defined in one figure, it is not needed to be further defined or explained in subsequent figures.

The above-mentioned are merely particular embodiments of the present disclosure, while the scope of protection of the present disclosure is not limited thereto. Any variations or substitutions, that would readily occur to any skilled person familiar with the present technical field, should fall into the scope of protection of the present disclosure. Therefore, the scope of protection of the present disclosure should be determined by the scope of protection of the claims.

### INDUSTRIAL APPLICABILITY

The generation method and apparatus for obstacle distance determining image provided in the present disclosure enable the user to determine an approximate distance between the obstacle behind the automobile and the automobile by observing the obstacle distance determining image, so as to avoid occurrence of accidents. Moreover, the user is able to more precisely determine the distance between the obstacle and the automobile. Further, since the accuracy of the generation method and apparatus for obstacle distance determining image provided in the present disclosure is quite high, the user is able to more precisely determine the distance between the obstacle behind the automobile and the automobile.

1-16. (canceled)

17. A generation apparatus for generating an obstacle distance determining image, wherein the generation apparatus comprises:
an information receiving unit, configured to receive a first image taken in a viewing direction from an automobile cab towards a tail, with the first image sent by a first image collecting apparatus, and receive a second image taken in a viewing direction away from the tail outside the automobile, with the second image sent by a second image collecting apparatus;
a wireframe analysis unit, configured to perform a wireframe analysis on the first image to acquire an initial outline of a target characteristic object in the viewing direction from the automobile cab towards the tail, wherein the target characteristic object comprises at least one window feature and external scene features visible through the window feature;
an error adjustment unit, configured to perform error adjustment to the initial outline according to the external scene features visible through the window feature and the second image to obtain a real outline of the target characteristic object in the viewing direction from the automobile cab towards the tail; and
an image generation unit, configured to overlap the second image and the real outline, to generate an obstacle distance determining image.

18. The generation apparatus of claim 17, wherein the automobile is provided with a distance detector which is configured to detect a distance between the automobile and an obstacle behind the tail, the information receiving unit is further configured to receive distance information between the automobile and the obstacle behind the tail sent by the distance detector, and the image generation apparatus further comprises:
a real outline adjustment unit, configured to adjust a size of the real outline of the target characteristic object according a pre-stored automobile model, a height from the first image collecting apparatus to the ground, distances from the first image collecting apparatus to a rear window, a rear left window, and a rear right window, a width of an automobile body, a length and a clear height of the rear window, a height from the rear window to the ground, a height from the second image collecting apparatus to the ground, a left-right viewing direction and an upward viewing direction of the second image collecting apparatus, a horizontal angle of installation of the second image collecting apparatus, and the distance information between the automobile and the obstacle behind the tail; and
the image generation unit, configured to overlap the second image and an adjusted real outline of the target characteristic object to generate the obstacle distance determining image.

19. The generation apparatus of claim 18, wherein the image generation unit comprises:
an overlapped image generation module, configured to overlap the second image and the adjusted real outline, in order to generate an overlapped image;
a minimum-distance obstacle selecting module, configured to select an obstacle at a minimum distance from the automobile, according to the distance information; and
a state updating module, configured to select an overlapped area of the real outline and the obstacle at the minimum distance from the automobile, and update a display state of the real outline of the target characteristic object within the overlapped area to a display state different from the display state of the real outline of the target characteristic object outside the overlapped area, so that the display state of the real outline of the target characteristic object within the overlapped area is not the same as the display state of the real outline of the target characteristic object outside the overlapped area, wherein the display state is a color display state and/or a line shape display state.

20. The generation apparatus of claim 17, wherein the wireframe analysis unit comprises:
an outline drawing module, configured to perform the wireframe analysis on the first image, and draw an outline of a scene characteristic object in the viewing direction from the automobile cab towards the tail; and
an outline extracting module for the target characteristic object, configured to extract the initial outline of the target characteristic object from the outline of the scene characteristic object in the viewing direction from the automobile cab towards the tail.

21. The generation apparatus of claim 17, wherein the error adjustment unit comprises:
an image extracting module, configured to extract the external scene features visible through the window feature;
a correspondence establishment module, configured to establish correspondence between an area characterizing an external scene feature in an image of the second image and the external scene feature; and
a solving module for solving offset and distortion, configured to solve offset and distortion of the initial outline according to the correspondence between an area characterizing an external scene feature in the image of the second image and the external scene feature, and obtain the real outline.

22. A generation method for obstacle distance determining image, wherein the generation method comprises steps of:
receiving a first image in a viewing direction from an automobile cab towards a tail, with the first image sent by a first image collecting apparatus and receiving a second image in a viewing direction away from the tail outside the automobile, with second image sent by a second image collecting apparatus;
performing wireframe analysis on the first image to acquire an initial outline of a target characteristic object in the viewing direction from the automobile cab towards the tail, wherein the target characteristic object comprises at least one window feature and external scene features visible through the window feature;
performing error adjustment to the initial outline according to the external scene features visible through the window feature and the second image to obtain a real outline of the target characteristic object in the viewing direction from the automobile cab towards the tail; and
overlapping the second image and the real outline to generate an obstacle distance determining image.

23. The generation method of claim 22, wherein the automobile is provided with a distance detector which is configured to detect a distance between the automobile and an obstacle behind the tail, and after the step of performing error adjustment to the initial outline according to the external scene features visible through the window feature and the second image to obtain the real outline of the target characteristic object in the viewing direction from the automobile cab towards the tail, the generation method further comprises:
receiving distance information between the automobile and the obstacle behind the tail obtained by the distance detector;
adjusting a size of the real outline of the target characteristic object according to a pre-stored automobile model, a height from the first image collecting apparatus to the ground, a distance from the first image collecting apparatus to a rear window, a distance from the first image collecting apparatus to a rear left window, a distance from the first image collecting apparatus to a rear right window, a width of an automobile body, a length and a clear height of the rear window, a height from a lower edge of the rear window to the ground, a height from the second image collecting apparatus to the ground, a left-right viewing direction and an upward viewing direction of the second image collecting apparatus, a horizontal angle of installation of the second image collecting apparatus, and the distance information; and
the step of overlapping the second image and the real outline to generate an obstacle distance determining image comprises:
overlapping the second image and an adjusted real outline of the target characteristic object to generate the obstacle distance determining image.

24. The generation method of claim 23, wherein the step of overlapping the second image and the real outline to generate an obstacle distance determining image comprises:
overlapping the second image and the real outline to generate an overlapped image;
selecting an obstacle at a minimum distance from the automobile according to the distance information; and
selecting an overlapped area of the real outline and the obstacle at the minimum distance from the automobile, and updating a display state of the real outline of the target characteristic object within the overlapped area to a display state different from a display state of the real outline of the target characteristic object outside the overlapped area, so that the display state of the real outline of the target characteristic object within the overlapped area is not the same as the display state of the real outline of the target characteristic object outside the overlapped area, wherein the display state comprises at least one of a color display state and a line shape display state.

25. The generation method of claim 22, wherein the step of performing wireframe analysis on the first image to acquire an initial outline of a target characteristic object in a viewing direction from the automobile cab towards the tail comprises:
performing the wireframe analysis on the first image, and drawing an outline of a scene characteristic object in the viewing direction from the automobile cab towards the tail; and
extracting the initial outline of the target characteristic object from the outline of the scene characteristic object in the viewing direction from the automobile cab towards the tail.

26. The generation method of claim 22, wherein the step of performing error adjustment to the initial outline according to the external scene features visible through the window feature and the second image to obtain a real outline of the target characteristic object in the viewing direction from the automobile cab towards the tail comprises:
extracting the external scene features visible through the window feature;
establishing correspondence between an area characterizing an external scene feature in an image of the second image and the external scene features; and
solving offset and distortion of the initial outline according the correspondence between an area characterizing an external scene feature in the image of the second image and the external scene features, and obtain the real outline.

27. An electronic device, comprising:
a memory;
a processor; and
a generation apparatus, wherein the generation apparatus is installed in the memory and comprises one or more software functional modules executed by the processor, the image generation apparatus comprises:
an information receiving unit, configured to receive a first image in a viewing direction from an automobile cab towards a tail sent by a first image collecting apparatus and receive a second image in a viewing direction away from the tail outside the automobile sent by a second image collecting apparatus;
a wireframe analysis unit, configured to perform wireframe analysis on the first image to acquire an initial outline of a target characteristic object in the viewing direction from the automobile cab towards the tail, wherein the target characteristic object comprises at least one window feature and external scene features visible through the window feature;
an error adjustment unit, configured to perform error adjustment to the initial outline according to the external scene features visible through the window feature and the second image to obtain a real outline of the target characteristic object in the viewing direction from the automobile cab towards the tail; and
a generation unit, configured to overlap the second image and the real outline to generate an obstacle distance determining image.

28. The electronic device of claim 27, wherein the automobile is provided with a distance detector which is configured to detect a distance between the automobile and an obstacle behind the tail, the information receiving unit is further configured to receive distance information, sent by the distance detector, between the automobile and the obstacle behind the tail, and the image generation apparatus further comprises:
a real outline adjustment unit, configured to adjust a size of the real outline of the target characteristic object according a pre-stored automobile model, a height from the first image collecting apparatus to the ground, distances from the first image collecting apparatus to a rear window, a rear left window, and a rear right window, a width of an automobile body, a length and a clear height of the rear window, a height from the rear window to the ground, a height from the second image collecting apparatus to the ground, a left-right viewing direction and an upward viewing direction of the second image collecting apparatus, a horizontal angle of installation of the second image collecting apparatus, and the distance information between the automobile and the obstacle behind the tail;
the generation unit, configured to overlap the second image and the adjusted real outline of the target characteristic object to generate the obstacle distance determining image.

29. The electronic device of claim 28, wherein the image generation unit comprises:
an overlapped image generation module, configured to overlap the second image and the adjusted real outline to generate an overlapped image;
a minimum-distance obstacle selecting module, configured to select an obstacle at a minimum distance from the automobile according to the distance information; and
a state updating module, configured to select an overlapped area of the real outline and the obstacle at the minimum distance from the automobile, and update a display state of the real outline of the target characteristic object within the overlapped area to a display state different from the display state of the real outline of the target characteristic object outside the overlapped area, so that the display state of the real outline of the target characteristic object within the overlapped area is not the same as the display state of the real outline of the target characteristic object outside the overlapped area, wherein the display state is a color display state and/or a line shape display state.

30. The electronic device of claim 27, wherein the wireframe analysis unit comprises:
an outline drawing module, configured to perform the wireframe analysis on the first image, and draw an outline of a scene characteristic object in the viewing direction from the automobile cab towards the tail; and
an outline extracting module for target characteristic object, configured to extract the initial outline of the target characteristic object from the outline of the scene characteristic object in the viewing direction from the automobile cab towards the tail.

31. The electronic device of claim 27, wherein the error adjustment unit comprises:
an image extracting module, configured to extract the external scene features visible through the window feature;
a correspondence establishment module, configured to establish correspondence between an area characterizing an external scene feature in an image of the second image and the external scene feature; and
a module for solving offset and distortion, configured to solve offset and distortion of the initial outline according the correspondence between an area characterizing an external scene feature in the image of the second image and the external scene feature, and obtain the real outline.

32. The generation apparatus of claim 18, wherein the wireframe analysis unit comprises:
an outline drawing module, configured to perform the wireframe analysis on the first image, and draw an outline of a scene characteristic object in the viewing direction from the automobile cab towards the tail; and
an outline extracting module for the target characteristic object, configured to extract the initial outline of the target characteristic object from the outline of the scene characteristic object in the viewing direction from the automobile cab towards the tail.

33. The generation apparatus of claim 19, wherein the wireframe analysis unit comprises:
an outline drawing module, configured to perform the wireframe analysis on the first image, and draw an outline of a scene characteristic object in the viewing direction from the automobile cab towards the tail; and
an outline extracting module for the target characteristic object, configured to extract the initial outline of the target characteristic object from the outline of the scene characteristic object in the viewing direction from the automobile cab towards the tail.

34. The generation method of claim 23, wherein the step of performing wireframe analysis on the first image to acquire an initial outline of a target characteristic object in a viewing direction from the automobile cab towards the tail comprises:
performing the wireframe analysis on the first image, and drawing an outline of a scene characteristic object in the viewing direction from the automobile cab towards the tail; and
extracting the initial outline of the target characteristic object from the outline of the scene characteristic object in the viewing direction from the automobile cab towards the tail.

35. The generation method of claim 24, wherein the step of performing wireframe analysis on the first image to acquire an initial outline of a target characteristic object in a viewing direction from the automobile cab towards the tail comprises:
performing the wireframe analysis on the first image, and drawing an outline of a scene characteristic object in the viewing direction from the automobile cab towards the tail; and
extracting the initial outline of the target characteristic object from the outline of the scene characteristic object in the viewing direction from the automobile cab towards the tail.

36. The electronic device of claim 28, wherein the wireframe analysis unit comprises:
an outline drawing module, configured to perform the wireframe analysis on the first image, and draw an outline of a scene characteristic object in the viewing direction from the automobile cab towards the tail; and
an outline extracting module for target characteristic object, configured to extract the initial outline of the target characteristic object from the outline of the scene characteristic object in the viewing direction from the automobile cab towards the tail.
